(19) United States
(12) Patent Application Publication
(10) Pub. No.: US 2025/0075143 A1
(43) Pub. Date: Mar. 6, 2025

(54) BIOLUBRICANTS SYNTHESIS FROM OIL/FAT OZONIZED-DERIVED PRODUCTS

(71) Applicant: Purdue Research Foundation, West Lafayette, IN (US)

(72) Inventors: Nathan Mosier, West Lafayette, IN (US); Junli Liu, West Lafayette, IN (US)

(21) Appl. No.: 18/820,325

(22) Filed: Aug. 30, 2024

Related U.S. Application Data
(60) Provisional application No. 63/579,571, filed on Aug. 30, 2023.

(51) Int. Cl. C10M 105/38; C11C 3/00

(52) U.S. Cl. CPC C10M 105/38; C11C 3/003; C11C 3/006; C10M 2207/2835

(57) ABSTRACT

Methods for making diverse high-quality biolubricants using carboxylic acid and dicarboxylic acids produced from ozone cracking of lipids. The method can include reacting a fatty acid with one or more alcohols, diols, and/or triols to esterify the fatty acid to form esters having a viscosity index of from 100 to 185, according to ASTM-D2270. The methods can also include reacting a carboxylic acid and/or dicarboxylic acid with one or more alcohols, diols, and/or triols to esterify the acid to form one or more diesters and/or oligoesters having a viscosity index of from 100 to 185, according to ASTM D 2270. The carboxylic acids and dicarboxylic acids can be nonanoic acid, malonic acid, propanoic acid, hexanoic acid, and azelaic acid, and can be derived from oxidation of one or more lipids by ozone cracking.

### BACKGROUND

### Field of the Invention

Embodiments of the present disclosure generally relate to biolubricants. More particularly, embodiments relate to biolubricants synthesized from oxidation products of biologically derived oils/fats.

### Description of the Related Art

Global warming, resulting from the increased carbon dioxide level in the atmosphere by fossil energy usage, has caught attention. Carbon dioxide emissions were about 5 billion tons in the United States in 2021, and the transportation and industrial sectors account for over 50% of the total emissions. One of the essential products in these sectors is lubricants, which are widely used in automobile, marine, aerospace, and industry. Lubricants have an annual global market size of 130 billion dollars and the potential to be 180 billion dollars by 2030.

Lubricants are mainly produced from petroleum products. However, natural-based fluids have become viable alternatives to fossil-based lubricants and play a critical role in decarbonizing the lubricant industry. For example, plant and other biologically derived oils and fats can be used as lubricants with great viscosity index, high flash point, and good lubricity. In addition, these natural oil-based lubricants are biodegradable and environmentally friendly. However, they exhibit some disadvantages, such as poor low-temperature performance, low oxidation stability, worse thermal stability, etc. Therefore, some modifications of natural-based plant oils or fats have been tried, such as transesterification, hydrogenation, epoxidation, etc.

Triglycerides, the basic molecules in oils/fats, are converted to fatty acid esters (FAEs) by transesterification with alcohols with the help of acidic or basic catalysts. This process is similar to biodiesel production. The resulting products have similar viscosities to the oil or fats but exhibit low oxidation stability and poor low-temperature performance since they have the same fatty acid profile. Other studies have tried transesterification with other polyols, such as trimethylolpropane (TMP), neopentyl glycol (NPG), etc. The products from transesterification with polyols exhibit significant improvement in low-temperature performance. However, oxidation stability depends on the source of FAEs.

Hydrogenation of the oils/fats involves the addition of hydrogen atoms to carbon-carbon double bonds to make them saturated. Though full hydrogenation can improve oxidation stability, the resulting products have poor low-temperature performance. Some studies have been carried out to partially hydrogenate the oils or fats by converting linoleic acid or linolenic acid to oleic acid. The resulting products have significantly improved oxidation stability while still keeping liquid. However, the synthesis route of partial hydrogenation requires high temperatures (250-300° C.), high pressure (25-35 MPa), and expensive catalysts, such as platinum and palladium.

Epoxidation of oils/fats can convert carbon-carbon double bonds to epoxides by reaction with peroxy acids in the presence of a catalyst, such as mineral acid, acid ion exchange resin, metal catalyst, or enzymes. Alternatively, the hydroxy group can be polymerized to form polyether or react with acid to do the esterification to improve the oxidation stability. The epoxidized oils/fats show improved oxidation stability.

There is still a need, therefore, for methods to improve the low-temperature performance, thermal stability and oxidation stability of non-fossil-based oils and fats to replace fossil-based lubricants.

### SUMMARY OF THE INVENTION

Methods for making biolubricants are provided herein. In at least one embodiment, high oleic oils can be oxidized through ozone cracking to one or more dicarboxylic acids (e.g., azelaic acid and malonic acid) and monocarboxylic acids (e.g., nonanoic acid) with a high yield. These acids can then be reacted with one or more diols, triols and/or other polyols at conditions sufficient to esterify the acid(s) to form esters therefrom that are suitable for use as lubricants.

In at least one specific embodiment, a biolubricant is made by reacting a fatty acid with at least one diol to esterify the fatty acid at conditions sufficient to form a fatty acid ester having a viscosity index of from 100 to 185, according to ASTM-D2270.

In at least one other specific embodiment, a biolubricant is made by oxidizing oil or fat with ozone to provide nonanoic acid; and reacting nonanoic acid with at least one diol to esterify the nonanoic acid at conditions sufficient to form a fatty acid ester having a viscosity index of from 100 to 185, according to ASTM-D2270.

In at least one other specific embodiment, a biolubricant is made by oxidizing oil or fat with ozone to provide a fatty acid comprising nonanoic acid, azelaic acid, or a mixture of both; reacting the fatty acid with at least one diol at conditions sufficient to esterify the fatty acid to form a fatty acid ester having a viscosity index of from 100 to 185, according to ASTM-D2270.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIGS. 1A-1F show the FTIR analysis of reaction mixtures prepared according to one or more embodiments provided herein. In particular, FIG. 1A shows the FTIR spectra of ethylene glycol (EG), nonanoic acid (NA), and resulting nonanoate (EGNE). FIG. 1B shows 1,2 propanediol (12PDO), nonanoic acid, and resulting nonanoate (12PDNE). FIG. 1C shows 1,3 propanediol (13PDO), nonanoic acid, and resulting nonanoate (13PDNE). FIG. 1D shows glycerol, nonanoic acid, and resulting glycerol trinonanoate (TGNE). FIGS. 1E and 1F show dimethyl azelate, glycerol, and resulting oligoesters (TG3DMA2 and GDMA).

FIGS. 2A-2E show the DSC analysis of the biolubricants, synthesized according to one or more embodiments described herein, to illustrate low-temperature performance. FIG. 2A shows the synthesized nonanoate (EGNE) from nonanoic acid and ethylene glycol. FIG. 2B shows the synthesized nonanoate (12PDNE) from nonanoic acid and 1,2 propanediol. FIG. 2C shows the synthesized nonanoate (13PDNE) from nonanoic acid and 1,3 propanediol. FIG. 2D shows the synthesized glycerol trinonanoate (TGNE) from glycerol, and nonanoic acid. FIGS. 2E and 2F show the synthesized oligoesters (TG3DMA2 and GDMA) from dimethyl azelate and glycerol.

FIGS. 3A-3F depict the TGA analysis of the biolubricants, synthesized according to one or more embodiments described herein, to illustrate thermal stability. In particular, FIG. 3A shows synthesized nonanoate (EGNE) from nonanoic acid and ethylene glycol. FIG. 3B shows the synthesized nonanoate (12PDNE) from nonanoic acid and 1,2 propanediol. FIG. 3C shows the synthesized nonanoate (13PDNE) from nonanoic acid and 1,3 propanediol. FIG. 3D shows the synthesized glycerol trinonanoate (TGNE) from glycerol, and nonanoic acid. FIGS. 3E and 3F show the synthesized oligoesters (TG3DMA2 and GDMA) from dimethyl azelate and glycerol.

FIG. 4A depicts the TGA analysis of methyl nonanoate (MNE) from nonanoic acid and methanol, ethyl nonanoate (ENE) from nonanoic acid and ethanol, propyl nonanoate (PNE) from nonanoic acid and 1-propanol, and butyl nonanoate (BNE) from nonanoic acid and 1-butanol.

FIG. 4B depicts the TGA analysis of isopropyl nonanoate (IPNE) from nonanoic acid and 2-propanol, isobutyl nonanoate (IBNE) from nonanoic acid and isobutanol, and isopentyl nonanoate (IPENE) from nonanoic acid and iospentanol.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

In the following discussion and in the claims, the singular forms “a”, “an”, and “the” are intended to include the plural forms as well, unless the context clearly indicates otherwise. Further, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case, does not include any other component to a level greater than 3 wt %.

The term “or” is intended to encompass both exclusive and inclusive cases, i.e., “A or B” is intended to be synonymous with “at least one of A and B,” unless otherwise expressly specified herein. Moreover, certain embodiments and features will be described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

The term “wt %” means percentage by weight, “vol %” means percentage by volume, “mol %” means percentage by mole, “ppm” means parts per million, and “ppm wt” and “ppmw” are used interchangeably and mean parts per million on a weight basis. All concentrations herein, unless otherwise stated, are expressed on the basis of the total amount of the composition in question.

The term “high oleic acid” means any oil or oily mixture that contains at least 75 wt % of oleic acid. Suitable high oleic acids for use herein can also contain at least 80 wt %, at least 85 wt %, at least 90 wt %, at least 93 wt %, at least 95 wt %, at least 97 wt %, or at least 99 wt %. of oleic acid. The concentration of oleic acid in the high oleic acid can also range from a low of about 75 wt %, 78 wt %, or 82 wt % to a high of about 88 wt %, 90 wt %, or 95 wt %. In some embodiments, the high oleic acid consists of oleic acid or consists essentially of oleic acid.

The terms “low saturated free fatty acid” and “low saturated FFA” are interchangeable and both mean less than 10 wt % of saturated free FFA, or less than 8 wt % or less than 5 wt %, or less than 3 wt %, or less than 2 wt % or less than 1 wt %. A low saturated free fatty acid (FFA) can also have a saturated FFA content that ranges from a low of 0.01 wt %, 0.05 wt %, or 1.0 wt % to a high of 3 wt %, 7 wt % or 10 wt %.

The terms “low polyunsaturated free fatty acid” and “low polyunsaturated FFA” are interchangeable and both mean less than 20 wt % of polyunsaturated FFA, or less than 18 wt % or less than 15 wt %, or less than 13 wt %, or less than 21 wt % or less than 10 wt %. A low polyunsaturated free fatty acid (FFA) can also have a polyunsaturated FFA content that ranges from a low of 1.0 wt %, 2.0 wt %, or 3.0 wt % to a high of 13 wt %, 17 wt % or 20 wt %.

Unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

Biolubricants synthesized from plant lipids or other non-fossil-based oils or fats, and methods for making same are provided. In at least one specific embodiment, the biolubricants are synthesized from a high oleic oil. High oleic oils are new oil varieties characterized by high oleic acid, low saturated FFA, and low polyunsaturated FFA. High oleic oils were initially intended to increase oxidation stability and improve human health, but industrial applications, such as biolubricants, provide additional opportunities to utilize them. A preferred source of high oleic oil is soybeans.

In at least one specific embodiment, the biolubricants can be prepared by at least partially oxidizing plant lipids or other non-fossil-based oils or fats to provide one or more types of fatty acids. The fatty acids are preferably medium-chain fatty acids having an aliphatic tail that contains between 4 and 12 carbon atoms. The aliphatic tail also can have 2, 3, or 4 to 8, 10, or 12 carbon atoms. These one or more fatty acids can then be reacted with one or more alcohols to esterify the fatty acid(s) to form a fatty acid ester that is suitable for use as a lubricant.

It was surprising and unexpected that the non-fossil-based biolubricants synthesized from a high oleic oil have longer oxidation stability than current biolubricants; have higher thermal stability than current biolubricants; and can be adjusted to meet low-temperature environment applications. It was also surprising and unexpected to discover that the viscosity indices of these biolubricants synthesized from a high oleic oil can range from 100 to 190. The viscosity indices also can range from 100 to 185; 150 to 185; and 150 to 190. The viscosity indices also can range from a low of about 100, 115, or 125 to a high of about 165, 185, or 190.

In one or more other embodiments, a method for making biolubricants from a high oleic oil is provided. High oleic oils can be cleaved through ozonolysis (i.e. ozone cracking) to dicarboxylic acids (e.g., azelaic acid and malonic acid) and monocarboxylic acids (e.g., nonanoic acid) with a high yield. The cleavage is preferably done by ozone cracking provide one or more types of fatty acids. The resulting acids can then be reacted with one or more diols, triols, or other polyols to form esters therefrom that are suitable for use as lubricants. Nonanoic acid is a primary carboxylic acid in the ozone cracking of oleic acid, a mono-unsaturated omega-9 fatty acid found in various animal and vegetable sources.

The high oleic oils and/or oleic acid can be derived from any suitable animal fats and/or vegetable oils. For example, high oleic soybean oils include oil varieties characterized by a high content of oleic acid, low saturated free fatty acid (FFA), and low polyunsaturated FFA. High oleic oils increase the stability of oil and improve human health, and industrial applications such as biofuels, and biochemicals are additional opportunities for these products.

Suitable alcohols for the esterification reaction can be or can include one or more diols, triols and/or other polyols. Such alcohols can be linear or branched or a mix of both linear and branched. The one or more alcohols can have 1 to 28 carbon atoms, such as 1 to 16 carbon atoms; 1 to 12 carbon atoms; 1 to 6 carbon atoms; 2 to 6 carbon atoms; 2 to 12 carbon atoms; 2 to 10 carbon atoms; or 2 to 8 carbon atoms. The one or more alcohols can be or can include n-alcohols having 1 to 12 carbon atoms or 2-12 carbon atoms. The one or more alcohols also can be or can include n-alcohols having 1 to 6 carbon atoms or 2-6 carbon atoms. The one or more alcohols also can be or can include iso-alcohols having 1 to 12 carbon atoms. The one or more alcohols also can be or can include iso-alcohols having 1 to 6 carbon atoms. The one or more alcohols also can be derived from syngas, a mixture of hydrogen and carbon monoxide. The one or more alcohols also can be derived from sugar or lignocellulose fermentation. The one or more alcohols also can be derived from biomass pyrolysis.

In at least one specific embodiment, the one or more alcohols can be or can include 1,3 propanediol and/or 1,2 propanediol. These 1,3 propanediol or 1,2 propanediol can be fermented or chemically synthesized from glycerol. In at least one specific embodiment, the one or more alcohols can be or can include glycerol.

In one or more specific embodiments, glycerin can be oxidized using ozone to provide a fatty acid comprising nonanoic acid, azelaic acid, or a mixture of both. These acids can then be reacted with at least one polyol to esterify the fatty acid to form a fatty acid ester. In one or more specific embodiments, glycerin can react with azelaic acid, malonic acid, nonanoic acid, and/or derivatives thereof to form one or more triglycerides or oligoesters suitable for use as lubricants. Glycerin is a readily available by-product of current biodiesel production and soap, as well as a by-product of the hydrolysis of animal fats, plant fat and vegetable oils. One or more suitable polyols, including glycerol, can be converted from glycerin by a biological fermentation process or chemical process.

In one or more embodiments above or elsewhere herein, one or more catalysts can be used in the reaction of the one or more fatty acids and the one or more alcohols to improve the reaction rate and yield. Any suitable acid catalyst can be used. For example, catalysts can include any one or more Bronstead acids. The catalyst can be homogenous or heterogeneous. The catalyst can be supported or unsupported. Suitable catalysts include methanesulfonic acid (MSA) and sulfuric acid. Ion exchange resins (strong acid type) can also be used. Other suitable catalysts include heterogeneous catalysts, such as MgF₂ and ZnF₂, are also able to do this conversion.

Preferred reaction pressure is at or near atmospheric pressure. Preferred reaction temperatures are about the approximate boiling points of the alcohol(s) to reach the fastest reaction rates. For example, suitable reaction temperatures include 60-70° C. for methanol; 72-82° C. for ethanol; 92-102° C. for 1-propanol; 78-88° C. for 2-propanol; 113-123° C. for 1-butanol; 105-115° C. for iso-butanol; and 126-136° C. for iso-pentanol. Additional reaction temperatures include 65° C. for methanol; 78° C. for ethanol; 97° C. for 1-propanol; 83° C. for 2-propanol; 118° C. for 1-butanol; 108° C. for iso-butanol; and 131° C. for iso-pentanol. In other embodiments, suitable reaction temperatures can range from a low of about 60, 70, or 80° C. to a high of about 110, 125, or 140° C.

After esterification, the resulting esters or oligoesters can be used as a base oil and/or lubricant due to their excellent viscosity, high flash point, and lubricity properties as well as significantly improved low-temperature performance and oxidation stability.

The resulting FAEs exhibit excellent low-temperature performance, excellent oxidation stability, and decreased nitrogen oxides emissions. These significantly improved qualities allow the FAEs to serve as biolubricants as well as biofuels, or biofuel components. In addition, the production process has the potential to be more economical than conventional routes due to lower capital cost, low energy consumption, high FAE yield, and high value of the by-products. In addition, the methods provided herein also can increase sustainability by carbon sequestration because of the renewability of feedstocks.

Additional aspects of the present disclosure include the following embodiments.

Embodiment I: A method for making a biolubricant, comprising: reacting a fatty acid with at least one diol or at least one triol at conditions sufficient to esterify the fatty acid to form a fatty acid ester having a viscosity index of from 100 to 185, according to ASTM-D2270.

Embodiment II: The method according to Embodiment I, wherein the fatty acid is nonanoic acid, azelaic acid, or a mixture thereof.

Embodiment III: The method according to Embodiments I or II, wherein the nonanoic acid is an ozonized product of a high oleic oil.

Embodiment IV: The method according to Embodiment II, wherein the azelaic acid is an ozonized product of one or more lipids.

Embodiment V: The method, according to any of Embodiments I through IV, wherein the fatty acid is produced by oxidizing an oil containing oleic acid using ozone cracking.

Embodiment VI: The method according to any of Embodiments I through V, wherein the at least one diol or triol has 2 to 12 carbon atoms.

Embodiment VII: The method according to any of Embodiments I through VI, wherein the at least one diol or triol has 2 to 6 carbon atoms.

Embodiment VIII: The method according to any of Embodiments I through VII, wherein the at least one diol or triol is selected from the group consisting of ethylene glycol, 1,2 propanediol, 1,3 propanediol, and glycerol.

Embodiment IX: A method for making a biolubricant, comprising: oxidizing a high oleic oil with ozone to provide one or more fatty acids comprising nonanoic acid, azelaic acid, malonic acid, hexanoic acid, or propanoic acid; and reacting the one or more fatty acids with at least one diol or triol to esterify the one or more fatty acids at conditions sufficient to provide a fatty acid ester having a viscosity index of from 100 to 185, according to ASTM-D2270.

Embodiment X: The method according to Embodiment IX, wherein the high oleic oil is derived from soybeans.

Embodiment XI: The method according to Embodiments IX or X, wherein at least one diol or triol has 2 to 12 carbon atoms.

Embodiment XII: The method according to any of Embodiments IX through XI, wherein the at least one diol or triol has 2 to 6 carbon atoms.

Embodiment XIII: The method according to any of Embodiments IX through XII, wherein the at least one diol or triol is selected from the group consisting of ethylene glycol, 1,2 propanediol, 1,3 propanediol, and glycerol.

Embodiment XIV: A method for making a biolubricant, comprising: oxidizing a high oleic oil with ozone to provide one or more fatty acids; and reacting glycerin and/or glycerol with the one or more fatty acids to form one or more triglycerides or oligoesters having a viscosity index of from 100 to 185, according to ASTM-D2270.

Embodiment XV: The method according to Embodiment XIV, wherein the glycerin is derived from animal fat, plant fat or petroleum.

Embodiment XVI: The method according to Embodiments XIV or XV, wherein the high oleic oil is derived from soybeans.

Embodiment XVII: The method according to Embodiments XIV through XVI, wherein the one or more fatty acids comprises azelaic acid.

Embodiment XVIII: The method according to Embodiments XIV through XVII, wherein the one or more fatty acids are selected from the group consisting of nonanoic acid, azelaic acid, malonic acid, hexanoic acid, and propanoic acid.

### EXAMPLES

The foregoing discussion can be further described with reference to the following non-limiting examples. Although the following examples are directed to specific embodiments, they are not to be viewed as limiting in any specific respect.

Various FAE/biolubricants were synthesized from oil/fat ozone-cracked products. The alcohols used were ethylene glycol, 1,2 propanediol, 1,3 propanediol, and glycerol. The resulting FAE/biolubricants had excellent viscosity indexes and viscosity classification. The biolubricants also had excellent thermal and oxidation stabilities. The samples, namely TGNE (Mw≈513), 12PDNE (Mw≈357), and the two medium-molecular weight molecules (Mw<1000) particularly showed excellent low-temperature performance.

### Example 1 (“Ex.1”)

In this example, nonanoic acid (≥96%, Sigma Aldrich Inc.) was reacted with one or more alcohols to form esters in the presence of methanesulfonic acid (MSA, 99%, Sigma Aldrich Inc.) as the homogenous catalyst. To prepare these esters, 6 moles of methanol, ethanol, 1-propanol, 2-propanol, 1-butanol, or 2-butanol were put into a 1-L flask with I mole of nonanoic acid. Then, 1.94 g of methanesulfonic acid (MSA) solution was added to the mixture. The flask was refluxed at the boiling point of the alcohol for 1 to 5 hours. Then, the extra alcohol and water were evaporated using a rotary evaporator under the vacuum at about −25 inch Hg. Then, the additional 3 moles of the same alcohol were put into the flask for another 3 hours reaction at the boiling point of the alcohol. The residual alcohol and water were removed from the mixtures using a rotary evaporator. The residual mixture was added with DI water and hexene to remove MSA in the aqueous layer. The step was repeated for several times until the pH of aqueous phase reached 6.5 to 7.5. The bottom aqueous layer was drained and the top organic layer was transferred into a flask. The hexane was removed using a rotary evaporator and the purified products were analyzed and characterized by various tests, such as FTIR, cloud point, freezing point, density, viscosity, and differential scanning calorimetry (DSC). The obtained esters were methyl nonanoate (MNE) from nonanoic acid and methanol, ethyl nonanoate (ENE) from nonanoic acid and ethanol, propyl nonanoate (PNE) from nonanoic acid and 1-propanol, isopropyl nonanoate (IPNE) from nonanoic acid and 2-propanol, butyl nonanoate (BNE) from nonanoic acid and 1-butanol, isobutyl nonanoate (IBNE) from nonanoic acid and isobutanol, and isopentyl nonanoate (IPENE) from nonanoic acid and iospentanol.

### Example 2 (“Ex.2”)

In this example, nonanoic acid (≥96%, Sigma Aldrich Inc.) was reacted with one or more diols and/or polyols to form esters in the presence of methanesulfonic acid (MSA, 99%, Sigma Aldrich Inc.) as the homogenous catalyst. To prepare these esters, 0.5 moles of ethylene glycol, 1,2 propanediol, or 1,3 propanediol were put into a 1-L flask with 1 mole of nonanoic acid. Then, 1.94 g of methanesulfonic acid (MSA) solution was added to the mixture. The flask was connected to a rotor evaporator with the vacuum at −10 inch Hg for 1 hour at a temperature of 100 to 120° C. Then, the vacuum was increased to −25 inch Hg for another 5 hours to remove water to move the reaction to the products. Then, the residual mixture was poured into a 1 L separation funnel, and 100 ml of hexane and 200 ml of deionized water were added and vigorously mixed. The mixture was allowed to settle for 30 mins before the layers were separated. The previous hexane/water extraction step was repeated over 5 times until the aqueous layer became clear, and the pH difference between the aqueous layer and de-ion water was less than 0.5. The top organic mixture was poured into a 1 L flask, and hexane/water was removed to obtain the purified esters. The purified esters were analyzed and characterized by various tests, such as FTIR, cloud point, freezing point, density, viscosity, and differential scanning calorimetry (DSC).

### Example 3 (“Ex.3”)

In this example, nonanoic acid (≥96%, Sigma Aldrich Inc.) was reacted with glycerol in the presence of methanesulfonic acid (MSA, 99%, Sigma Aldrich Inc.) as the homogenous catalyst. To prepare this ester, 0.5 moles of glycerol and 1.5 moles of nonanoic acid were put into a 1-L flask. Then, 1.94 g of methanesulfonic acid (MSA) solution was added to the mixture. The flask was connected to a rotor evaporator with the vacuum at −10 inch Hg for 1 hour at a temperature of 130 to 160° C. Then, the vacuum was increased to −25 inch Hg for another 5 hours to remove water to move the reaction to the products. Then, the residual mixture was poured into a 1 L separation funnel, and 100 ml of hexane and 200 ml of deionized water were added and vigorously mixed. The mixture was allowed to settle for 30 mins before the layers were separated. The previous hexane/water extraction step was repeated over 5 times until the aqueous layer became clear, and the pH difference between the aqueous layer and de-ion water was less than 0.5. The top organic mixture was poured into a 1 L flask, and hexane/water was removed to obtain the purified esters. The purified esters were analyzed and characterized by various tests, such as FTIR, cloud point, freezing point, density, viscosity, and differential scanning calorimetry (DSC).

### Example 4 (“Ex.4”)

In this example, two oligoesters (“Oligoester-1” and “Oligoester-2”) were prepared and analyzed. To prepare these oligoesters, 0.2 or 0.3 moles of glycerol and 0.3 moles of dimethyl azelate were put into a 500-mL three-neck flask. Then, 0.78 g of MSA was added to the mixture. The flask was heated by a heating mantle with a digital temperature controller (USA Lab Inc.) to 150° C. and held for 1 hour. Then, 0.5 mL/min nitrogen gas flow was transferred into the flask for 3 hours at 150° C. reaction temperature. Then, the reactor was connected to a condenser with a vacuum of −25 inch Hg for about 3 hours. The reaction mixture was cooled to room temperature to transfer to a glass bottle for analysis, such as FTIR, cloud point, freezing point, density, viscosity, and DSC, using the test procedures described below.

### FTIR Characterization

FTIR analysis was performed by a Nicolet Nexus FTIR (Thermo Fisher Scientific, USA), and the samples were analyzed in a spectral region between 4000 and 800 cm-1 with a 2 cm⁻¹ resolution. The samples for FTIR analysis included nonanoic acid, diols (ethylene glycol, 1,2 propanediol, and 1,3 propanediol), glycerol, and products formed from the reactions described previously.

### Cloud Point Detection

Cloud point was measured according to the ASTM D 2500. In the cloud point detection, a stainless steel cylinder was immersed in the ethanol bath, and the temperature was chilled by adding dry ice. A glass test tube with about 25 mL moisture-free sample was settled into the cylinder. The cloud point was recorded as the temperature of observing waxy clouds or haze.

### Density and Viscosity

The densities and viscosities of products were measured by a Stabinger viscometer (SVM 3001, Anton Paar) at 40° C. and 100° C. according to ASTM D 4052 and D 7042, respectively. Toluene was used as solvent between injections to clean the system, and the instrument was calibrated and checked for accuracy using APS3 and APN2B Anton Paar-certified standards.

Kinematic viscosity was determined according to ASTM D445 using an Antor Paar VSM 3001. Viscosity index was calculated according to ASTM-D2270.

### DSC Analysis

DSC analysis was performed by a Q 2000 DSC instrument (TA Instruments, England) with a refrigerated cooling accessory (TA Instruments, England). Nitrogen was purged into the system at 40 mL/min during analysis. The sample was cooled at the rate of 1° C./min to −40° C. after being at the isotherm at 20° C. for 3 mins. Then, it was heated to 20° C. at the rate of 1° C./min after being isotherm at −40° C. for 3 min. About 10 uL samples were used in each analysis.

### TGA Analysis

A TGA 4000 (Perkin Elmer, USA) was used to assess the thermal degradation by weight loss using nonisothermal and isothermal methods under a nitrogen atmosphere (20 mL/min). Nonisothermal heating was used to determine the Tₒₙₛₑₜ of biolubricants (esters and oligoesters) with 15-25 mg at 15° C./min from 40 to 550° C. Tₒₙₛₑₜ was calculated by the tangent intersection of the baseline and degradation curve. The tangent intersection method was performed within the Origin software.

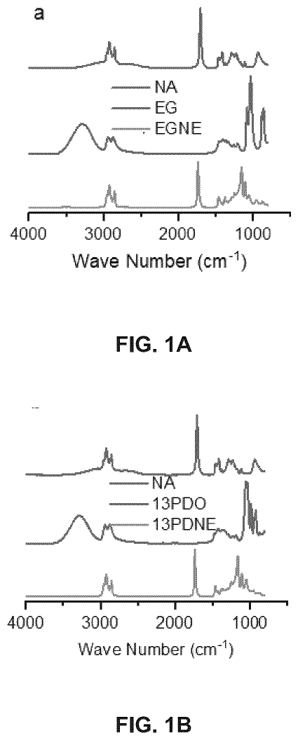

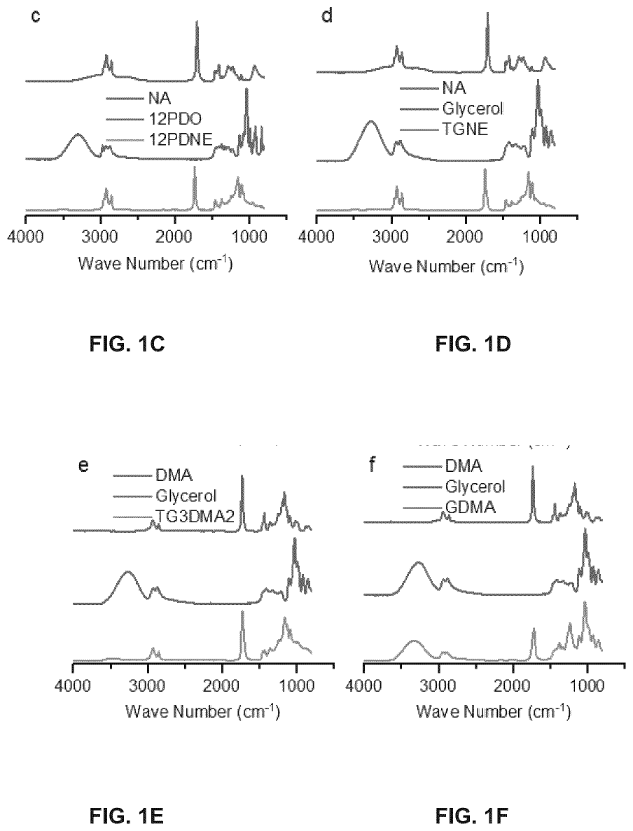

FIGS. 1A-1F show the FTIR analysis of the reaction mixtures. FIG. 1A shows the FTIR spectra of ethylene glycol (EG), nonanoic acid (NA), and resulting nonanoate (EGNE). FIG. 1B shows 1,2 propanediol (12PDO), nonanoic acid, and resulting nonanoate (12PDNE). FIG. 1C shows 1,3 propanediol (13PDO), nonanoic acid, and resulting nonanoate (13PDNE). FIG. 1D shows glycerol, nonanoic acid, and resulting glycerol trinonanoate (TGNE). FIGS. 1E and 1F show dimethyl azelate, glycerol, and resulting oligoesters (TG3DMA2 and GDMA).

The conversion of the carboxylic acid groups to esters was confirmed using the FTIR analysis, which shows two peak changes in FIGS. 1A-1D. Notably, the broach peak corresponding to OH in diols/glycerol between 3000-3500 cm⁻¹ disappeared in the final products. Also, the carbonyl group (C═O) corresponding to nonanoic acid shifted from 1705.6 cm-1 to 1735.7 cm⁻¹ in the formed nonanoate. The oligoester formation was confirmed by FTIR in FIGS. 1E and 1F by the disappearance of the OH peak in the formed oligoesters.

### Viscosity, Viscosity Index, and Viscosity Grade

The viscosity of the biolubricants varied significantly. The nonanoates had much lower viscosities than the oligoesters, ranging from 5 to 14 cSt. However, the oligoesters had a much higher viscosity above 1750 cSt. The biolubricants also exhibited an excellent viscosity index, ranging from about 150 to about 190. The widespread viscosity indicates that the biolubricants can have a broad application, either in motor oil, engine oil, or machinery grease.

TABLE 1
Viscosity, viscosity index, and viscosity grade of biolubricants

| | Kinematic viscosity | Viscosity | Viscosity |
|---|---|---|---|
| Biolubricant | (cSt, 40° C.) | index | classification |
| Ex. 1: MNE | 1.437 | — | — |
| Ex. 1: ENE | 1.452 | — | — |
| Ex. 1: PNE | 1.849 | — | — |
| Ex. 1: IPNE | 1.823 | — | — |
| Ex. 1: BNE | 2.077 | | ISO VG 2 |
| Ex. 1: IBNE | 2.106 | | ISO VG 2 |
| Ex. 1: IPENE | 2.313 | | ISO VG 2 |
| Ex. 2: EGNE | 5.6119 | 158 | ISO VG 7 |
| Ex. 2: 13PDNE | 6.5376 | 160 | ISO VG 7 |
| Ex. 2: 12PDNE | 5.8529 | 172 | ISO VG 7 |
| Ex. 3: TGNE | 13.104 | 154 | ISO VG 15 |
| Ex. 4: TG3DMA2 | 3052 | 186 | ISO VG 3200 |
| (Oligoester-1) | | | |
| Ex. 4: GDMA | 1753 | 154 | ISO VG 1500-2200 |
| (Oligoester-2) | | | |

### Low-Temperature Performance

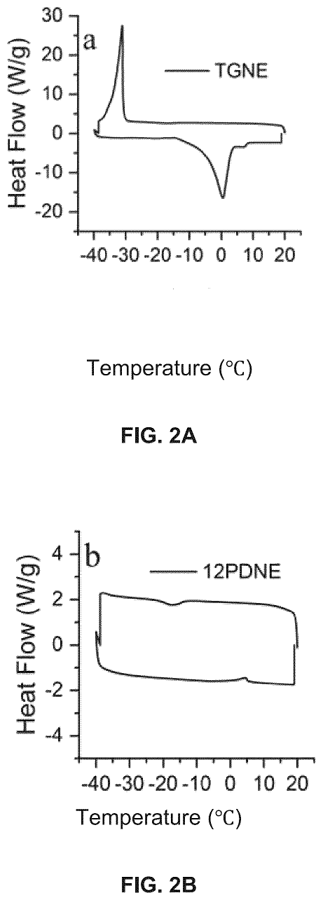

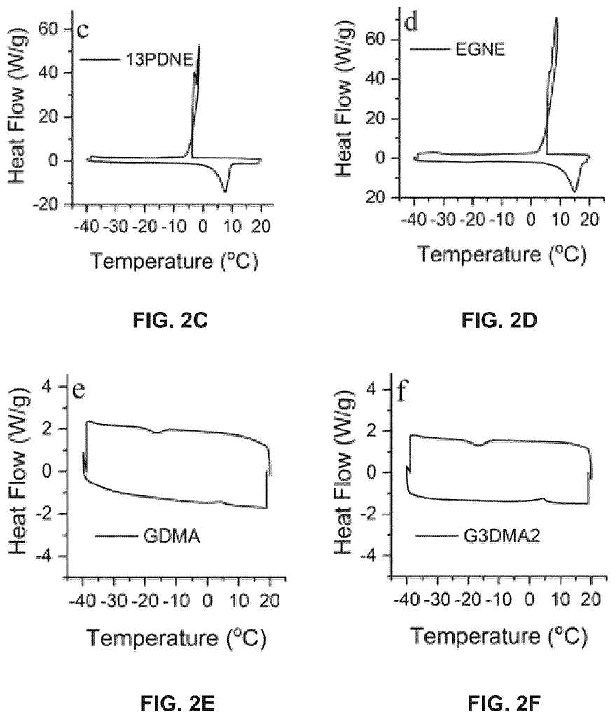

was evaluated by DSC analysis and/or ASTM D 2500 for the nonanoates. The biolubricants exhibited excellent low-temperature performance, as seen in FIGS. 2A-2F, which depict the DSC analysis of the biolubricants, as well as Table 2 below. FIG. 2A shows the synthesized nonanoate (EGNE) from nonanoic acid and ethylene glycol. FIG. 2B shows the synthesized nonanoate (12PDNE) from nonanoic acid and 1,2 propanediol. FIG. 2C shows the synthesized nonanoate (13PDNE) from nonanoic acid and 1,3 propanediol. FIG. 2D shows the synthesized glycerol trinonanoate (TGNE) from glycerol, and nonanoic acid, and FIGS. 2E and 2F show the synthesized oligoesters (TG3DMA2 and GDMA) from dimethyl azelate and glycerol. Table 2 below shows the cloud points of the nonanoates synthesized according to Example 1.

TABLE 2
Low-temperature performance of the Ex. 1 nonanoates:

| Biolubricants name | Cloud Point (° C.) |
|---|---|
| MNE | −35 |
| ENE | −42 |
| PNE | −43 |
| IPNE | −46 |
| BNE | −45 |
| IBNE | −57 |
| IPENE | −69 |

The oligoesters and 12PDNE did not show phase change for temperatures above −40° C. The low-temperature performance for the other three biolubricants followed TGNE>13PDNE>EGNE. The structure of the molecule significantly affected the low-temperature performance, and the branched structure was suitable for low-temperature performance. The crystallization of 1,3 PDNE and EGNE was exothermic, indicating some special uses, such as anti-slippery pavement.

### Thermal Stability Analysis

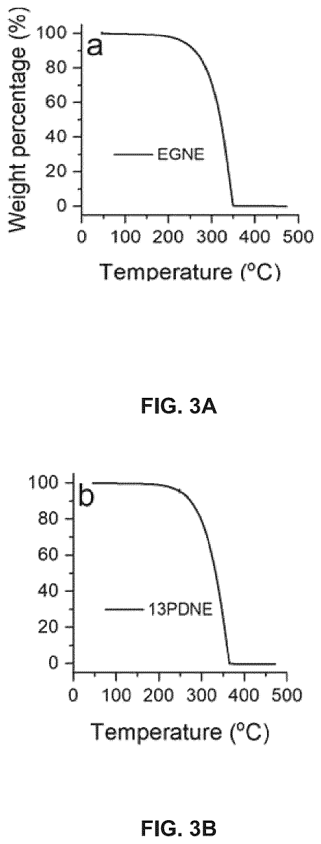

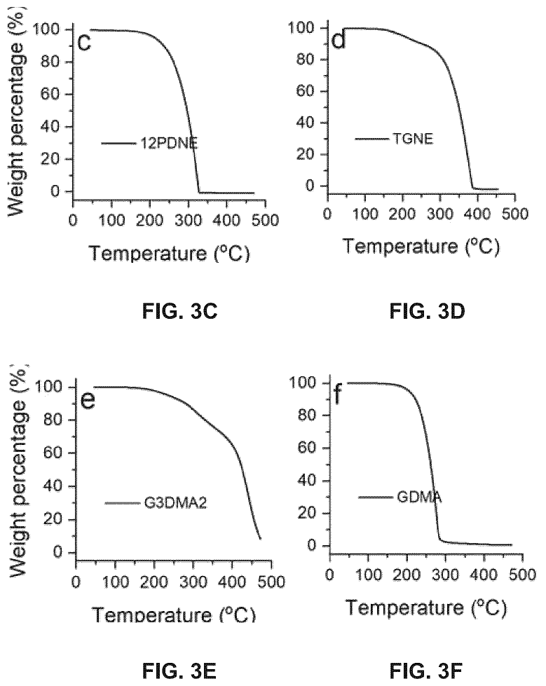

Thermal stability was evaluated by TGA analysis. The biolubricants showed excellent thermal stability without significant degradation below 200° C., as seen in FIGS. 3A-3F, which depict the TGA analysis of the biolubricants. FIG. 3A shows the synthesized nonanoate (EGNE) from nonanoic acid and ethylene glycol. FIG. 3B shows the synthesized nonanoate (12PDNE) from nonanoic acid and 1,2 propanediol. FIG. 3C shows the synthesized nonanoate (13PDNE) from nonanoic acid and 1,3 propanediol. FIG. 3D shows the synthesized glycerol trinonanoate (TGNE) from glycerol, and nonanoic acid. FIGS. 3E and 3F show the synthesized oligoesters (TG3DMA2 and GDMA) from dimethyl azelate and glycerol.

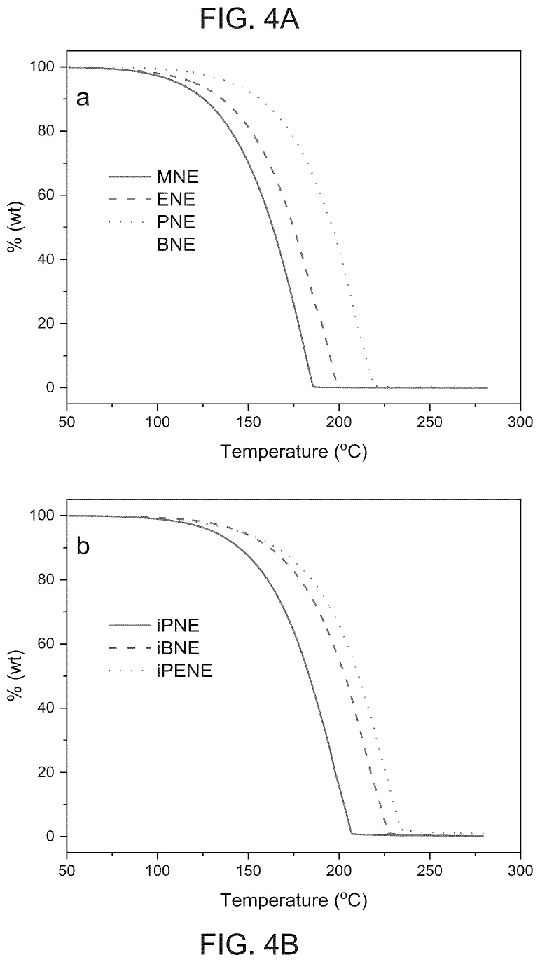

FIGS. 4A and 4B show the TGA analysis/thermal stability of the nonanoate synthesis from nonanoic acid and the various alcohols of Example 1. In particular, FIG. 4A shows the TGA analysis of methyl nonanoate (MNE) from nonanoic acid and methanol, ethyl nonanoate (ENE) from nonanoic acid and ethanol, propyl nonanoate (PNE) from nonanoic acid and 1-propanol, and butyl nonanoate (BNE) from nonanoic acid and 1-butanol. FIG. 4B shows the TGA analysis of isopropyl nonanoate (IPNE) from nonanoic acid and 2-propanol, isobutyl nonanoate (IBNE) from nonanoic acid and isobutanol, and isopentyl nonanoate (IPENE) from nonanoic acid and iospentanol.

### Oxidation Stability

The biolubricants also showed excellent oxidation stability. Table 3 below shows the oxidation stability of the nonanoates formed from nonanoic acid with the various alcohols in Example 1.

TABLE 3
oxidation stability of the Ex. 1 nonanoates
formed from nonanoic acid.

| | MNE | ENE | PNE | BNE | IPNE | IBNE | IPENE |
|---|---|---|---|---|---|---|---|
| Hours | >99 | >114 | >77 | >83 | >62 | >59 | >30 |

As previously mentioned, certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

The foregoing has also outlined features of several embodiments so that those skilled in the art can better understand the present disclosure. Although various terms have been defined herein, those skilled in the art should also realize that any term used in a claim and not defined above should be given the broadest definition persons in the pertinent art have given that term as reflected in at least one printed publication or issued patent.

Those skilled in the art should also appreciate that they can readily use the present disclosure as a basis for designing or modifying other methods or devices for carrying out the same purposes and/or achieving the same advantages of the embodiments disclosed herein. Those skilled in the art should realize that such equivalent constructions do not depart from the spirit and scope of the present disclosure, and that they can make various changes, substitutions, and alterations herein without departing from the spirit and scope of the present disclosure, and the scope thereof is determined by the claims that follow.

What is claimed is:

1. A method for making a biolubricant, comprising:
reacting a fatty acid with at least one diol or at least one triol at conditions sufficient to esterify the fatty acid to form a fatty acid ester having a viscosity index of from 100 to 185, according to ASTM-D2270.

2. The method of claim 1, wherein the fatty acid is nonanoic acid, azelaic acid, or a mixture thereof.

3. The method of claim 2, wherein the nonanoic acid is an ozonized product of a high oleic oil.

4. The method of claim 2, wherein the azelaic acid is an ozonized product of one or more lipids.

5. The method of claim 1, wherein the fatty acid is produced by oxidizing an oil containing oleic acid using ozone cracking.

6. The method of claim 1, wherein the at least one diol has 2 to 12 carbon atoms.

7. The method of claim 1, wherein the at least one diol has 2 to 6 carbon atoms.

8. The method of claim 1, wherein the at least one diol or triol is selected from the group consisting of ethylene glycol, 1,2 propanediol, 1,3 propanediol, and glycerol.

9. A method for making a biolubricant, comprising:
oxidizing a high oleic oil with ozone to provide one or more fatty acids comprising nonanoic acid, azelaic acid, malonic acid, hexanoic acid, or propanoic acid; and
reacting the one or more fatty acids with at least one diol or triol to esterify the one or more fatty acids at conditions sufficient to provide a fatty acid ester having a viscosity index of from 100 to 185, according to ASTM-D2270.

10. The method of claim 9, wherein the high oleic oil is derived from soybeans.

11. The method of claim 9, wherein the at least one diol or triol has 2 to 12 carbon atoms.

12. The method of claim 9, wherein the at least one diol or triol has 2 to 6 carbon atoms.

13. The method of claim 9, wherein the at least one diol or triol is selected from the group consisting of ethylene glycol, 1,2 propanediol, 1,3 propanediol, and glycerol.

14. A method for making a biolubricant, comprising:
oxidizing a high oleic oil with ozone to provide one or more fatty acids; and
reacting glycerin and/or glycerol with the one or more fatty acids to form one or more triglycerides or oligoesters having a viscosity index of from 100 to 185, according to ASTM-D2270.

15. The method of claim 14, wherein the glycerin is derived from animal fat, plant fat or petroleum.

16. The method of claim 14, wherein the high oleic oil is derived from soybeans.

17. The method of claim 14, wherein the one or more fatty acids comprises azelaic acid.

18. The method of claim 14, wherein the one or more fatty acids are selected from the group consisting of nonanoic acid, azelaic acid, malonic acid, hexanoic acid, and propanoic acid.
